(19) United States
(12) Patent Application Publication
(10) Pub. No.: US 2006/0148395 A1
(43) Pub. Date: Jul. 6, 2006

(54) Coin counter

(75) Inventor: Li-Hui Kao, Yonghe City (TW)

Correspondence Address: TROXELL LAW OFFICE PLLC, SUITE 1404, 5205 LEESBURG PIKE, FALLS CHURCH, VA, 22041, US

(73) Assignees: Origo Klebe Technik Co., Ltd.; Scan Coin International AB

(21) Appl. No.: 11/008,940

(22) Filed: Dec. 13, 2004

(51) Int. Cl. G07D 1/00

(52) U.S. Cl. 453/57

(57) ABSTRACT

A coin counter includes a chassis supporting a rotary disk with a support bracket mounted above the rotary disk and two posts mounted to predetermined positions of the chassis; an adjusting mechanism mounted to the posts; a conveying mechanism supported by the support bracket and comprised of a support frame, a conveyor and an actuation element; a driving mechanism arranged below the chassis and coupled to the coin forwarding mechanism; a transmission mechanism coupled to the driving mechanism and also coupled to the rotary disk and comprised of a frame and a transmission shaft. Such an arrangement allows for modularization of the adjusting mechanism, the conveying mechanism, and the transmission mechanism, respectively, for easy disassembling, repairing, and maintenance.

### FIELD OF THE INVENTION

The present invention generally relates to a coin counter, and in particular to a coin counter comprising modularized adjusting mechanism, conveying mechanism, and transmission mechanism for easy disassembling/assembling, repairing, and maintenance of the coin counter.

### BACKGROUND OF THE INVENTION

A conventional coin counter comprises a support board or a chassis on which a rotary disk is mounted. A conveyor comprised of a conveying mechanism is arranged above the rotary disk and an actuation element is provided for driving the conveyor. A control circuit is provided adjacent the rotary disk for controlling the operation of the counter. An adjusting mechanism is provided next to the rotary disk for adjusting width and thickness of a coin passage. A coin dispenser is arranged at an end of the coin passage. A sensor electrically coupled to the control circuit is arranged alongside the coin passage for counting the number of the coins passing through the passage, respectively. An actuation mechanism is arranged below the support board and coupled to a gear train comprising mated gears. One of the gears is coupled to the rotary disk. The actuation mechanism and the conveying mechanism are electrically connected to the control circuit whereby the control circuit controls the actuation mechanism and the conveying mechanism. An enclosure houses the chassis and the components and/or sub-assemblies on the chassis. The enclosure defines a receiving hopper corresponding in position to the conveying mechanism whereby coins to be counted are deposited in the receiving hopper, which coins are then conveyed by the conveying mechanism to the rotary disk. By means of the rotation of the rotary disk, the coins are forced into the coin passage and then moved toward the coin dispenser at which the coins are discharged.

The conventional coin counter, although working well for counting coins, comprises a number of parts or sub-assemblies that must be assembled one by one. Further, due to the frequent use of the coin counter, especially in the financial business, maintenance and repairing are definitely needed after a period of use. Such a complicated construction comprised of a great number of parts makes it not possible for the general consumer or user to do repairing or maintenance by himself or herself. Thus, a maintenance technician must be called or the machine be sent back to the factory for repairing and maintenance. Those parts that are assembled together one by one to form the coin counter must be taken apart one by one in doing repairing or maintenance. This is certainly not time-efficient. In addition, such a great number of parts often result in lose of one or two small parts when these parts are taken apart for repairing of maintenance and this makes the maintenance and repairing operation difficult and inconvenient.

Thus, the present invention is aimed to provide a coin counter having a modularized construction for overcoming the drawbacks of the conventional coin counter.

### SUMMARY OF THE INVENTION

Thus, a primary objective of the present invention is to provide a coin counter comprising modularized adjusting mechanism, conveying mechanism, and transmission mechanism.

Another objective of the present invention is to provide a coin counter having a construction that allows for ready mounting/dismounting and thus easy maintenance and repairing by the general consumers so that costs of using and maintaining the coin counter can be reduced.

To achieve the above objective, in accordance with the present invention, a coin counter is provided, comprising a chassis supporting a rotary disk, a transmission element arranged below the rotary disk, a support bracket mounted above the rotary disk, a chute extending from a circumference of the rotary disk, two posts mounted adjacent one side of the chute, a width adjuster arranged on the other side of the chute; an adjusting mechanism mounted to the posts, comprising a resilient plate set arranged between the posts to cooperate with a leverage device below the chassis, and a coin forwarding mechanism and a thickness adjuster, the coin forwarding mechanism and the thickness adjuster each defining a fixing hole; a conveying mechanism mounted on the support bracket above the rotary disk, comprising a support frame in which a conveyor and an actuation element are arranged; a driving mechanism arranged under the chassis and coupled to the coin forwarding mechanism; a transmission mechanism coupled to the driving mechanism and also coupled to the transmission element of the rotary disk, the transmission mechanism comprising a frame and a transmission shaft rotatably supported in the frame. Such an arrangement allows for modularization of the adjusting mechanism, the conveying mechanism, and the transmission mechanism, respectively, for easy disassembling, repairing, and maintenance.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a coin counter constructed in accordance with the present invention;

FIG. 2 is a perspective view of the coin counter of the present invention with an enclosure removed to show inside details;

FIG. 3 is an exploded view of the inside structure of the coin counter in accordance with the present invention;

FIG. 4 is a plan view of a chassis of the coin counter in accordance with the present invention;

FIG. 5 is an enlarged perspective view of the coin counter taken at a bottom perspective of the chassis;

FIG. 6 is an exploded view of an adjusting mechanism of the coin counter in accordance with the present invention;

FIG. 7 is an exploded view of a conveying mechanism of the coin counter in accordance with the present invention; and

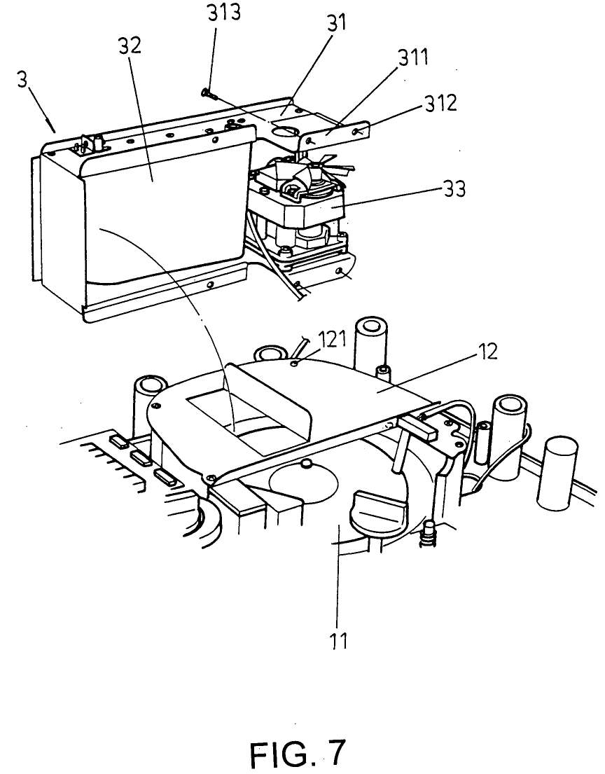

FIG. 8 is an exploded view of a transmission mechanism of the coin counter in accordance with the present invention.

### DETAILED DESCRIPTION OF THE PREFERRED EMBODIMENT

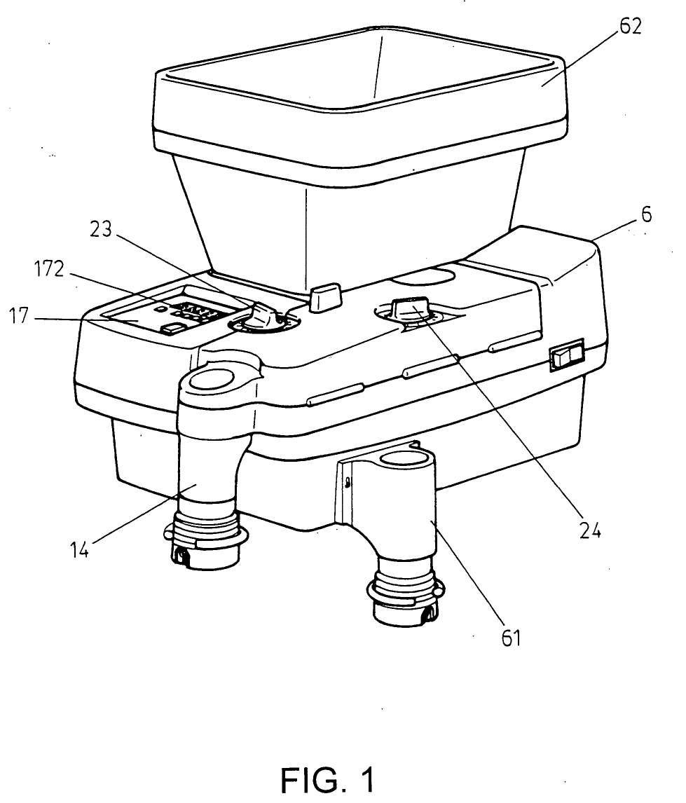

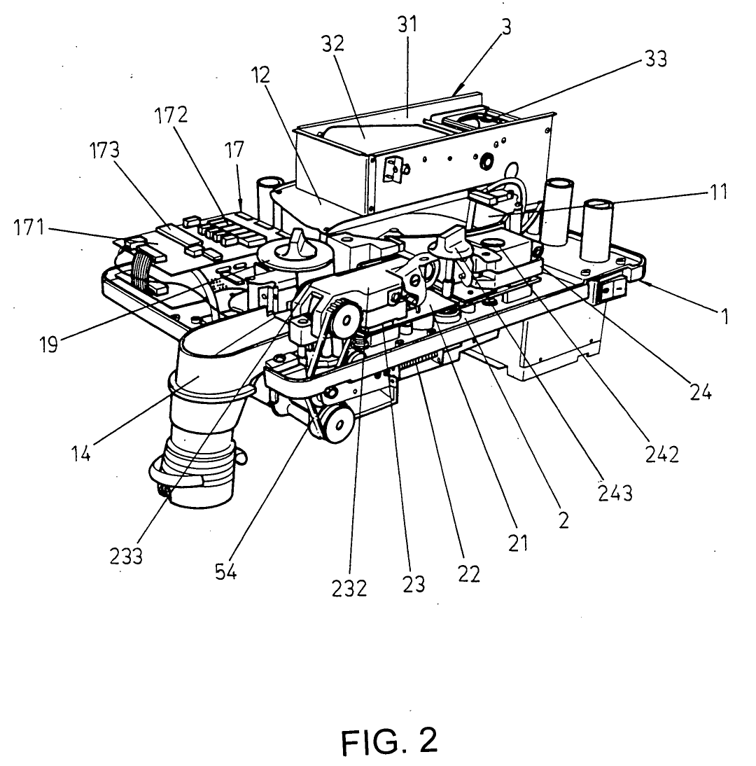

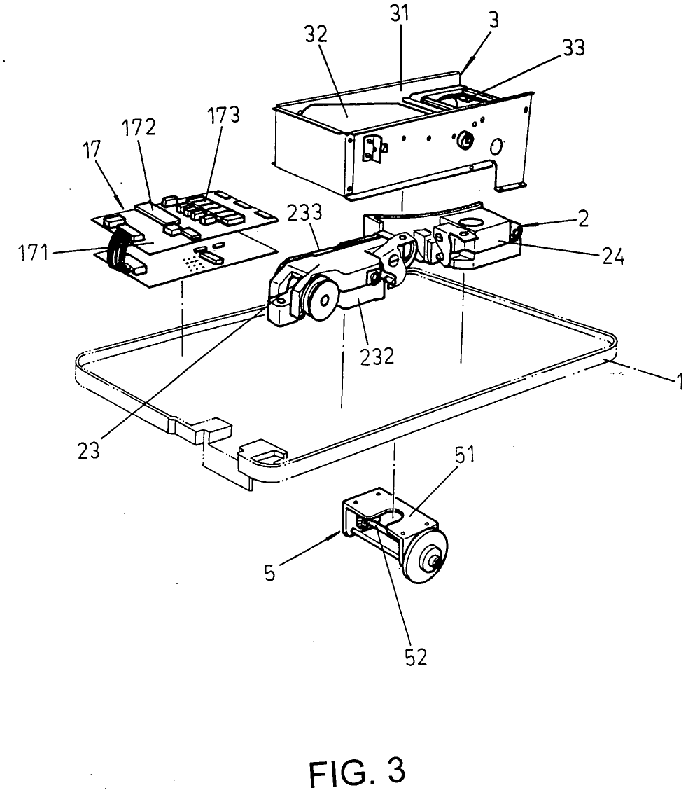

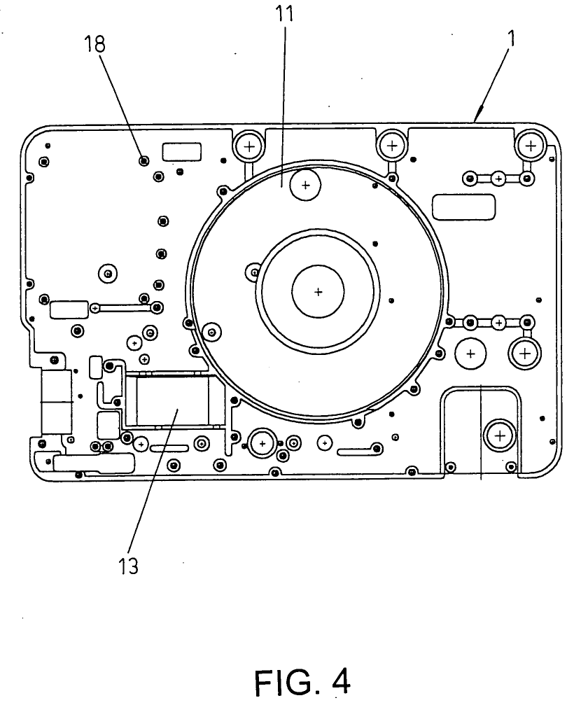

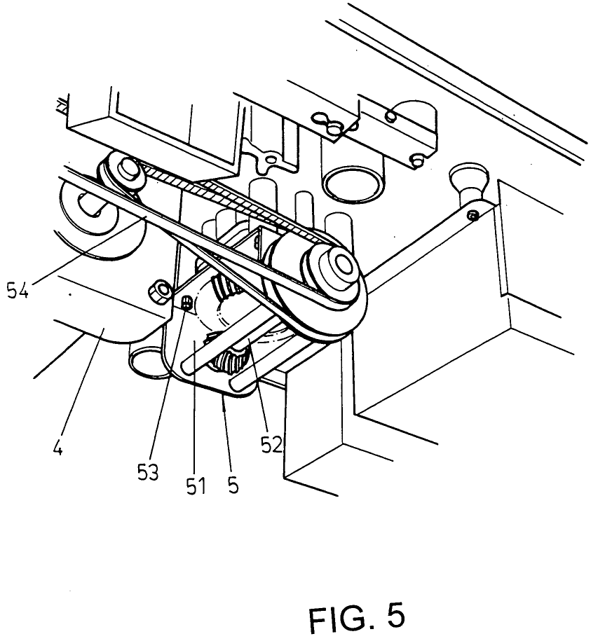

With reference to the drawings and in particular to FIGS. 1-5, a coin counter constructed in accordance with the present invention comprises a chassis 1 supporting an adjusting mechanism 2, a conveying mechanism 3, a driving mechanism 4, and a transmission mechanism 5. In accordance with the present invention, the adjusting mechanism 2, the conveying mechanism 3, and the transmission mechanism 5 are of modularization construction, respectively, to enhance assembling/disassembling, repairing, and maintenance of the coin counter.

The coin counter comprises a rotary disk 11 rotatably mounted on the chassis 1. A transmission member 111 is arranged under the rotary disk 11 for rotating the rotary disk 11. A support bracket 12 is arranged above the rotary disk 11 and defines at least one fixing hole 121. A chute 13 forming a coin passage extends from a circumference of the rotary disk 11 to a coin dispensing structure 14 arranged at an end of the chute 13. A sensor (not shown) is arranged between the chute 13 and the coin dispensing structure 14. Two posts 15, 16 are arranged at predetermined positions adjacent to one side of the chute 13. A control circuit device 17 is arranged at a predetermined position adjacent the rotary disk 11. The control circuit device 17 comprises a plurality of display elements 172 and a central processing unit (CPU) 173 mounted on a circuit board 171. On the other side of the chute 13, a width adjuster 19 is provided for setting width of the coin passage defined in the chute 13 for coins passing therethrough. The chassis 1 forms at least one fixing hole 18, which cooperates with a fastener (not shown) to secure the adjusting mechanism 2, the conveying mechanism 3, the driving mechanism 4, and the transmission mechanism 5 on the chassis 1. Enclosure 6 houses the chassis 1, as well as the other components mounted on the chassis 1. The enclosure 6 forms a receiving hopper 62 at a predetermined position and comprises a coin return structure 61 at a position corresponding to an underside of the chute 13 in which for example a coin return opening in communication with the coin return structure is defined for the returned coins.

The adjusting mechanism 2 is mounted to the posts 15, 16. The adjusting mechanism 2 comprises a resilient plate set 21 mounted between the posts 15, 16 to cooperate with a leverage device 22 arranged below the chassis 1, and a coin forwarding mechanism 23 and a thickness adjuster 24. The coin forwarding mechanism 23 and the thickness adjuster 24 define fixing holes 231, 241, respectively, for fitting over the posts 15, 16 to fix the coin forwarding mechanism 23 and the thickness adjuster 24 to the posts 15, 16. The coin forwarding mechanism 23 comprises a base 232 and a coin forwarding subassembly 233. The thickness adjuster 24 comprises a base 242 and an adjusting valve 243.

The conveying mechanism 3 is mounted on the support bracket 12 that is located above the rotary disk 11 and corresponds in position to the receiving hopper 62. The conveying mechanism 3 comprises a support frame 31 in which a conveyor 32 and an actuation element 33 are arranged. Flanges 311 extend from opposite sides of the support frame 31 of the conveying mechanism 3. At least one hole 312, which corresponds in position to the fixing hole 121 of the support bracket 12, is defined in the flange 311 whereby a fastener 313 engaging these holes 312, 121 is employed to secure the conveying mechanism 3 to the support bracket 12. The conveying mechanism 3 is electrically connected to the control circuit device 17 whereby the control circuit device 17 controls the operation of the conveying mechanism 3.

The driving mechanism 4 is arranged under the chassis 1 and is electrically connected to the control circuit device 17 whereby the control circuit device 17 controls the operation of the driving mechanism 4. The driving mechanism 4 is mechanically coupled to the coin forwarding mechanism 3.

The transmission mechanism 5 is coupled to the driving mechanism 4 by a coupling member 54. The transmission mechanism 5 is also coupled to transmission member 111 of the rotary disk 11. The transmission mechanism 5 is comprised of a frame 51 and a transmission shaft 52 rotatably supported in the frame 51. Fixing holes 511 are defined in predetermined positions of the frame 51 for receiving fasteners 53 to secure the transmission mechanism 5 to the chassis 1. By means of the transmission shaft 52, the load of the transmission mechanism 5 is uniform, leading to reduced noise, reduced vibration, and power loss of the transmission mechanism 5. Such a construction provides a novel improvement over the coin counter.

The operation of coin counting by the coin counter is generally known and will only be briefly described hereinafter. Before the coin counting operation starts, a user operates the width adjuster 19 and the thickness adjuster 24 to set the adjusting mechanism 2 to the diameter and thickness of the type of the coins to be counted. Thereafter, the user deposits the coins into the receiving hopper 62 and the conveying mechanism 3 transfers the coins to the rotary disk 11. The rotation of the rotary disk 11 induces a centrifugal force on each coin, which forces the coin into the chute 13. The coin forwarding mechanism 23 then moves the coin toward the coin dispensing structure 14. Since the adjusting mechanism 2 is set to the diameter and the thickness of the type of coins to be counted, coins having diameter and thickness matching the settings are allowed to pass through the chute 13 and discharged at the coin dispensing structure 14. When the coin is dispensed by the coin dispensing structure 14, the sensor that is arranged between the chute 13 and the coin dispensing structure 14 detects the coin whereby total number of the coins passing through the coin dispensing structure 14 can be counted. The count of the coins is displayed on the display elements 172. In case the diameter and/or thickness of a coin moving through the chute 13 is smaller than the settings of the adjusting mechanism 2, the coin drops out of the chute 13, for example through the coin return opening, and collected and discharged by the coin return structure 61 arranged below the chute 13. When the coin moving through the chute 13 has a diameter and/or thickness greater than the settings of the adjusting mechanism 2, the coin is kept inside the rotary disk 11 and cannot be moved into the chute 13 for example by the setting of the coin passage defined in the chute 13.

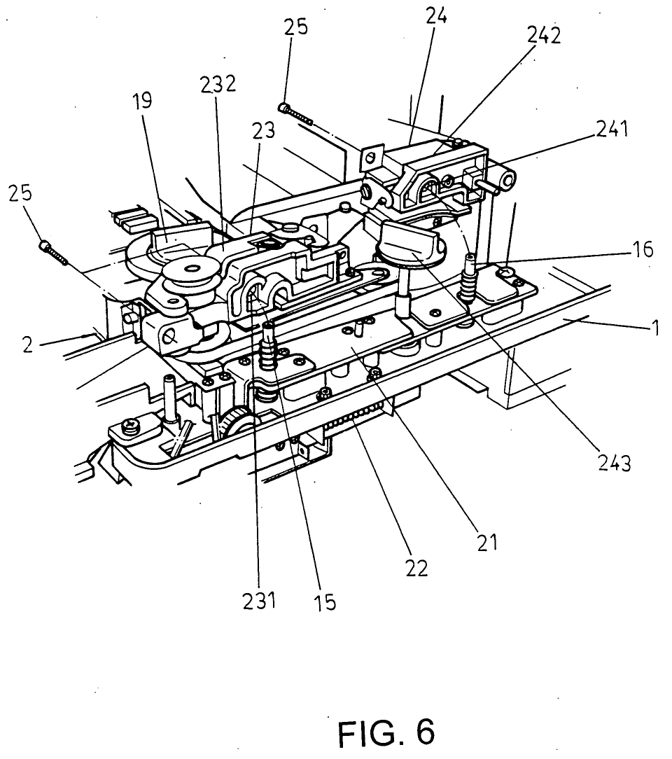

Also referring to FIG. 6, the adjusting mechanism 2 comprises a single module comprised of the resilient plate set 21 mounted between the posts 15, 16 for cooperation with the leverage device 22 arranged below the chassis 1, and the coin forwarding mechanism 23 and the thickness adjuster 24. The module is fixed to the posts 15, 16 by fitting the fixing holes 231, 241 defined in the coin forwarding mechanism 23 and the thickness adjuster 24 over the posts 15, 16, which are secured by fasteners 25. Modularization of the adjusting mechanism 2 makes it easy and possible for general consumers to do repairing and maintenance for the adjusting mechanism 2 by simply loosening fasteners 7. The module of the adjusting mechanism 2 can be easily re-mounted to the coin counter and secured again by simply tightening the fasteners.

Also referring to FIG. 6, the adjusting mechanism 2 comprises a single module comprised of the resilient plate set 21 mounted between the posts 15, 16 for cooperation with the leverage device 22 arranged below the chassis 1, and the coin forwarding mechanism 23 and the thickness adjuster 24. The module is fixed to the posts 15, 16 by fitting the fixing holes 231, 241 defined in the coin forwarding mechanism 23 and the thickness adjuster 24 over the posts 15, 16, which are secured by fasteners 25. Modularization of the adjusting mechanism 2 makes it easy and possible for general consumers to do repairing and maintenance for the adjusting mechanism 2 by simply loosening fasteners 7. The module of the adjusting mechanism 2 can be easily re-mounted to the coin counter and secured again by simply tightening the fasteners.

Also referring to FIG. 6, the adjusting mechanism 2 comprises a single module comprised of the resilient plate set 21 mounted between the posts 15, 16 for cooperation with the leverage device 22 arranged below the chassis 1, and the coin forwarding mechanism 23 and the thickness adjuster 24. The module is fixed to the posts 15, 16 by fitting the fixing holes 231, 241 defined in the coin forwarding mechanism 23 and the thickness adjuster 24 over the posts 15, 16, which are secured by fasteners 25. Modularization of the adjusting mechanism 2 makes it easy and possible for general consumers to do repairing and maintenance for the adjusting mechanism 2 by simply loosening fasteners 7. The module of the adjusting mechanism 2 can be easily re-mounted to the coin counter and secured again by simply tightening the fasteners.

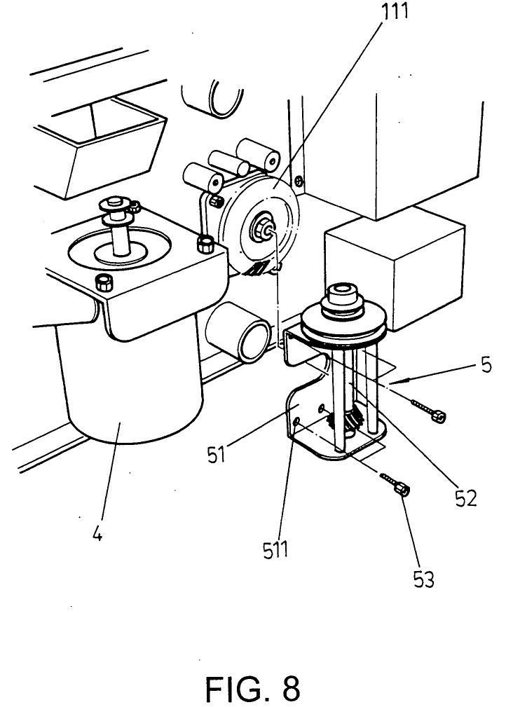

Also referring to FIG. 8, the transmission mechanism 5 is comprised of the frame 51 and the transmission shaft 52 rotatably supported in the frame 51. The frame 51 is attached to the chassis 1 by fasteners 53 that are received in the fixing holes 511 defined in predetermined positions of the frame 51. Thus, the general consumers can do repairing and maintenance of the transmission mechanism 5 by loosening the fastener 53 to remove the transmission mechanism 5 and the transmission mechanism 5 can be easily re-mounted to back to the coin counter by tightening the fasteners 53 again.

Thus, the coin counter in accordance with the present invention comprises modularized adjusting mechanism, conveying mechanism, and transmission mechanism, which allows for easy repairing and maintenance that can be performed by the general consumers themselves. There is no longer necessary to call for help of technician or to transport the counter back to the manufacturers for repairing services. The costs for manufacturing and repairing/maintenance can be reduced.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A coin counter comprising:
a chassis supporting a rotary disk, a transmission element arranged below the rotary disk, a support bracket mounted above the rotary disk, a chute extending from a circumference of the rotary disk, two posts mounted adjacent one side of the chute, a width adjuster arranged on the other side of the chute;
an adjusting mechanism mounted to the posts, comprising a resilient plate set arranged between the posts to cooperate with a leverage device below the chassis, and a coin forwarding mechanism and a thickness adjuster, the coin forwarding mechanism and the thickness adjuster each defining a fixing hole;
a conveying mechanism mounted on the support bracket above the rotary disk, comprising a support frame in which a conveyor and an actuation element are arranged;
a driving mechanism arranged under the chassis and coupled to the coin forwarding mechanism;
a transmission mechanism coupled to the driving mechanism and also coupled to the transmission element of the rotary disk, the transmission mechanism comprising a frame and a transmission shaft rotatably supported in the frame.

2. The coin counter as claimed in claim 1 further comprising an enclosure housing the chassis, the enclosure forming a receiving hopper corresponding in position to the conveying mechanism, the enclosure also forming a coin return opening below the chute.

3. The coin counter as claimed in claim 1, wherein the chassis forms at least one fixing hole.

4. The coin counter as claimed in claim 1, wherein the support bracket defines at least one fixing hole.

5. The coin counter as claimed in claim 1, wherein the coin forwarding mechanism comprises a base and a coin forwarding subassembly.

6. The coin counter as claimed in claim 1, wherein the thickness adjuster comprises a base and an adjusting valve.

7. The coin counter as claimed in claim 1, wherein the conveying mechanism comprises a support frame from which flanges extend, the flanges defining at least one hole.

8. The coin counter as claimed in claim 1 further comprising a control circuit device arranged at a predetermined position adjacent the rotary disk and electrically connected to the driving mechanism and the transmission mechanism for controlling the driving mechanism and the transmission mechanism, the control circuit device comprising a plurality of display elements and a central processing unit mounted on a circuit board.

9. The coin counter as claimed in claim 1 further comprising a coin dispensing structure arranged at an end of the chute.

10. The coin counter as claimed in claim 1, wherein the transmission mechanism is coupled to the driving mechanism by a coupling member, the frame of the transmission mechanism defining a plurality of fixing holes to receive fasteners that secure the transmission mechanism to the chassis.
